(19) United States
(12) Patent Application Publication
(10) Pub. No.: US 2025/0247593 A1
(43) Pub. Date: Jul. 31, 2025

(54) DOORBELL DEVICE

(71) Applicant: ALPHA NETWORKS INC., Hsinchu (TW)

(72) Inventor: HSIN-HONG CHEN, Hsinchu (TW)

(73) Assignee: ALPHA NETWORKS INC., Hsinchu (TW)

(21) Appl. No.: 18/790,980

(22) Filed: Jul. 31, 2024

(30) Foreign Application Priority Data
Jan. 31, 2024 (TW) 113103757

(51) Int. Cl. H04N 23/52; H04N 7/18

(52) U.S. Cl. CPC H04N 23/52; H04N 7/186

(57) ABSTRACT

A doorbell device includes a housing, an optical module, a circuit board, and a button assembly disposed in an opening of the housing. The optical module is disposed in the housing and is controllable to power up to photograph an environmental image and outputs an image signal; the circuit board is disposed in the housing and has several electronic components, a thermally conductive circuit, and a sensing switch on an outer surface of the circuit board; the electronic components includes an auxiliary function component and a primary function component electrically connected to the sensing switch, the optical module, and the auxiliary function component; the thermally conductive circuit is laid out on the outer surface, is electrically connected to the electronic components, and has an extending segment located in a sensing area of the circuit board; a pressing board corresponds to the sensing area and the sensing switch.

### BACKGROUND OF THE INVENTION

### Technical Field

The present invention relates generally to a doorbell device, and more particularly to a doorbell device, which has an effect of melting an ice.

### Description of Related Art

It is known that a doorbell device is an indispensable equipment in many places, such as houses, buildings, and companies. The earliest doorbell device is purely a mechanical device, which includes a button assembly. When a pressing board of the button assembly is pressed, the doorbell device generates a doorbell sound to have an effect of notifying. Nowadays, a doorbell device becomes a kind of smart appliances. In addition to a basic function of the doorbell sound, a circuit board is disposed in the doorbell device, so that electronic components such as an optical module and a motion sensor could be disposed on the circuit board, which adds a function of automatically sensing a moving object and a function of recording a video to the conventional doorbell device. In this way, the doorbell device is provided with the enhanced convenience in using and security management, so that the doorbell device could be transformed into a security system.

The pressing board of the button assembly is a movable component, so that a moisture or a mist could easily permeate into a periphery of the pressing board. Especially in cold areas, when an environmental temperature is less than zero degrees Celsius, the moisture existing in the periphery of the pressing board easily freezes, so that the pressing board would be stuck by an ice in the periphery of the pressing board and could not be pressed normally. As a result, the button assembly could not operate normally.

Therefore, the conventional doorbell device still has room for improvement.

### BRIEF SUMMARY OF THE INVENTION

In view of the above, the primary objective of the present invention is to provide a doorbell device, so that a thermal energy generated by a plurality of electronic components during an operation of the electronic components could be effectively transferred to a periphery of a pressing board of a button assembly through a thermally conductive circuit of a circuit board, thereby preventing the pressing board from being stuck by an ice in the periphery of the pressing board.

The present invention provides a doorbell device including a housing, an optical module, a circuit board, and a button assembly, wherein the housing has a front panel; the front panel has an opening; the optical module is disposed in the housing, wherein the optical module is controllable to power up to photograph an environmental image of an outside of the housing and outputs an image signal; the circuit board is disposed in the housing and has an outer surface, wherein the outer surface of the circuit board faces the front panel; a plurality of electronic components, a thermally conductive circuit, and a sensing switch are disposed on the outer surface of the circuit board; the electronic components include at least one primary function component and at least one auxiliary function component, wherein the at least one primary function component is electrically connected to the sensing switch, the optical module, and the at least one auxiliary function component; the at least one primary function component is adapted to control the optical module to power up and control the at least one auxiliary function component to power up; the at least one primary function component receives the image signal of the optical module and a trigger signal of the sensing switch; the outer surface of the circuit board has a sensing area, wherein the sensing area corresponds to the opening of the front panel and the sensing switch is located in the sensing area; the thermally conductive circuit is laid out on the outer surface of the circuit board and is electrically connected to the electronic components; the thermally conductive circuit has an extending segment, wherein the extending segment is located in the sensing area; the button assembly is disposed in the housing and is located in the opening of the front panel; the button assembly includes a pressing board, wherein the pressing board corresponds to the sensing area of the outer surface of the circuit board and the sensing switch of the outer surface of the circuit board; the pressing board is pressable to trigger the sensing switch to generate the trigger signal; the pressing board has a peripheral edge, wherein the peripheral edge has a bottom peripheral edge; wherein the extending segment of the thermally conductive circuit corresponds to the bottom peripheral edge of the pressing board.

With the aforementioned design, the doorbell device is provided with the thermally conductive circuit disposed on the circuit board, wherein the sensing area corresponds to the button assembly and the thermally conductive circuit has the extending segment located in the sensing area, so that the thermal energy generated by the electronic components during the operation of the electronic components could be transferred to the periphery of the pressing board of the button assembly through the thermally conductive circuit, thereby preventing the pressing board from being stuck and affected by the ice in the periphery of the pressing board.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the doorbell device according to an embodiment of the present invention;

FIG. 2 is an exploded view of the doorbell device according to the embodiment of the present invention;

FIG. 3 is a perspective view of the circuit board according to the embodiment of the present invention;

FIG. 4 is a schematic view of the doorbell device according to the embodiment of the present invention;

FIG. 5 is an exploded view of the button assembly according to the embodiment of the present invention;

FIG. 6 is a schematic view of the button assembly in FIG. 3, showing a location of the button assembly corresponding to the circuit board;

FIG. 7 is a front view of the doorbell device according to the embodiment of the present invention;

FIG. 8 is a sectional view along the 7-7 line in FIG. 7;

FIG. 9 is an enlarged view of a marked region A1 in FIG. 8;

FIG. 10 is a schematic view of a predetermined distance according to the embodiment of the present invention.

### DETAILED DESCRIPTION OF THE INVENTION

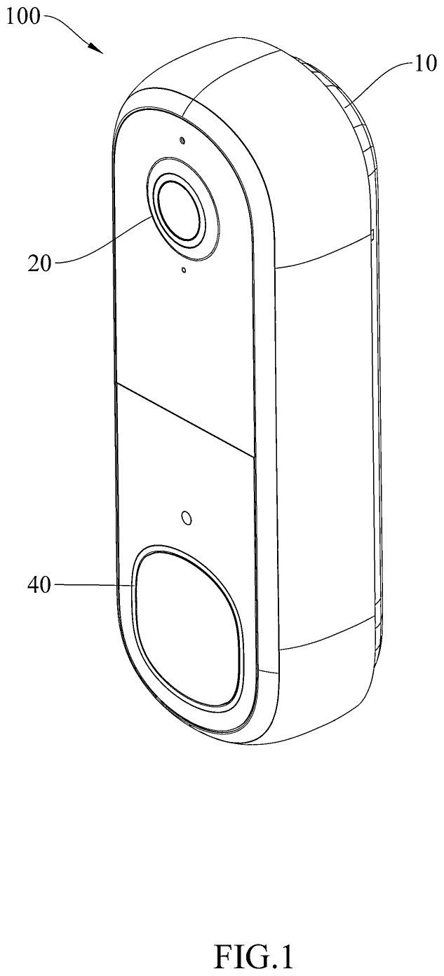

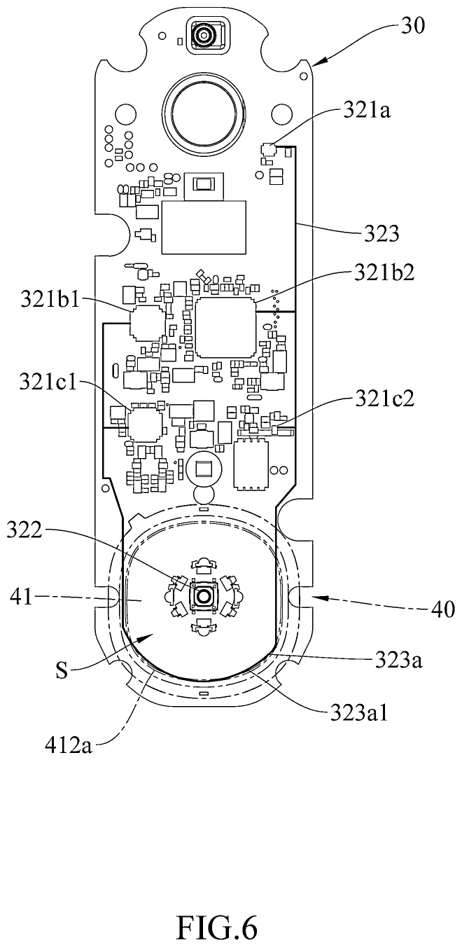

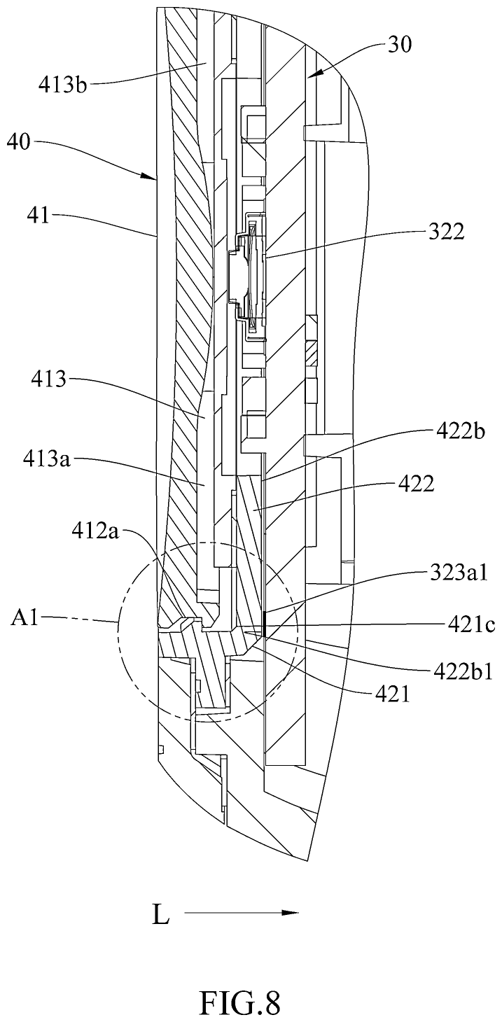

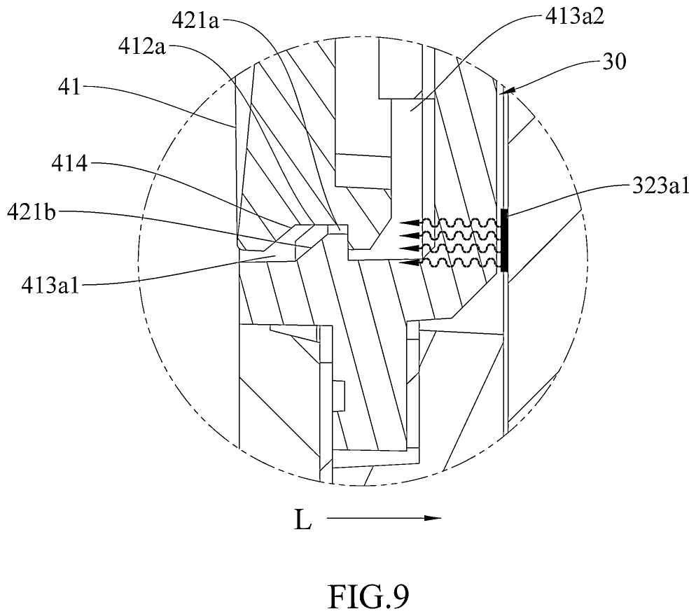

A doorbell device 100 according to an embodiment of the present invention is illustrated in FIG. 1 to FIG. 9 and includes a housing 10, an optical module 20, a circuit board 30, and a button assembly 40.

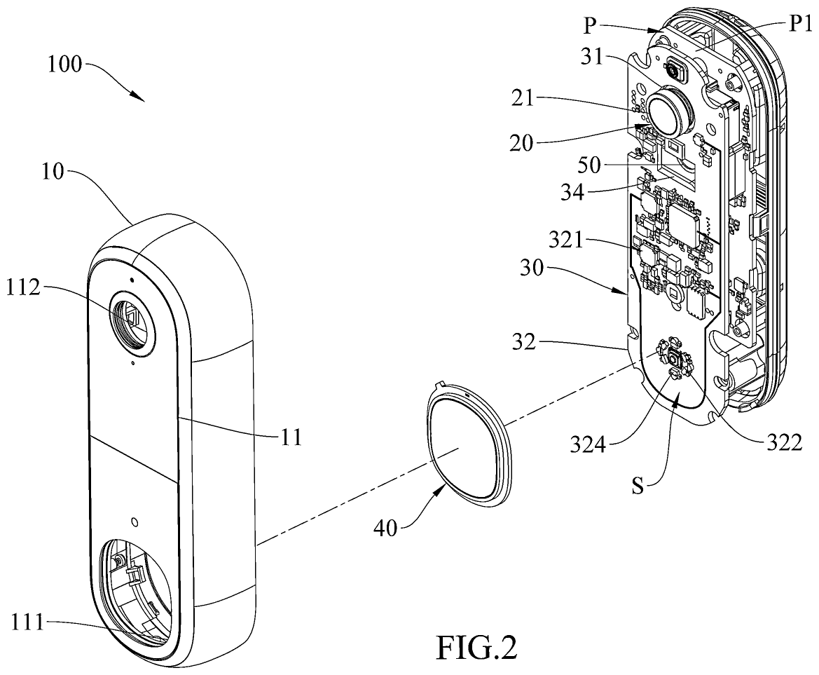

Referring to FIG. 1 and FIG. 2, the housing 10 has a front panel 11, wherein the front panel 11 has an opening 111 and a first through hole 112. The optical module 20 is located in the housing 10 and is disposed on an outer surface P1 of a rear circuit board P. The optical module 20 includes an image sensor and a camera lens 21, wherein the image sensor is disposed on the outer surface P1 of the rear circuit board P. The camera lens 21 extends outward into the first through hole 112 of the housing 10. In this way, an environmental image of an outside of the housing 10 could be photographed by the optical module 20 and the image sensor outputs an image signal.

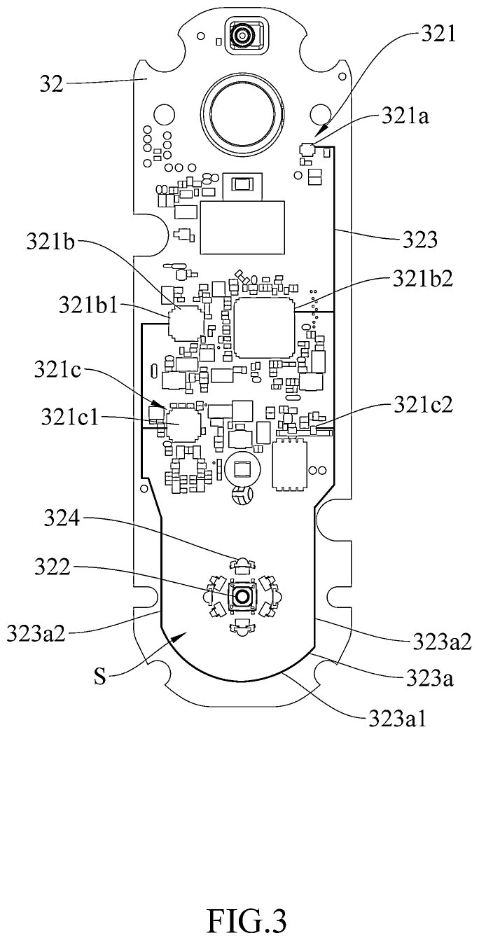

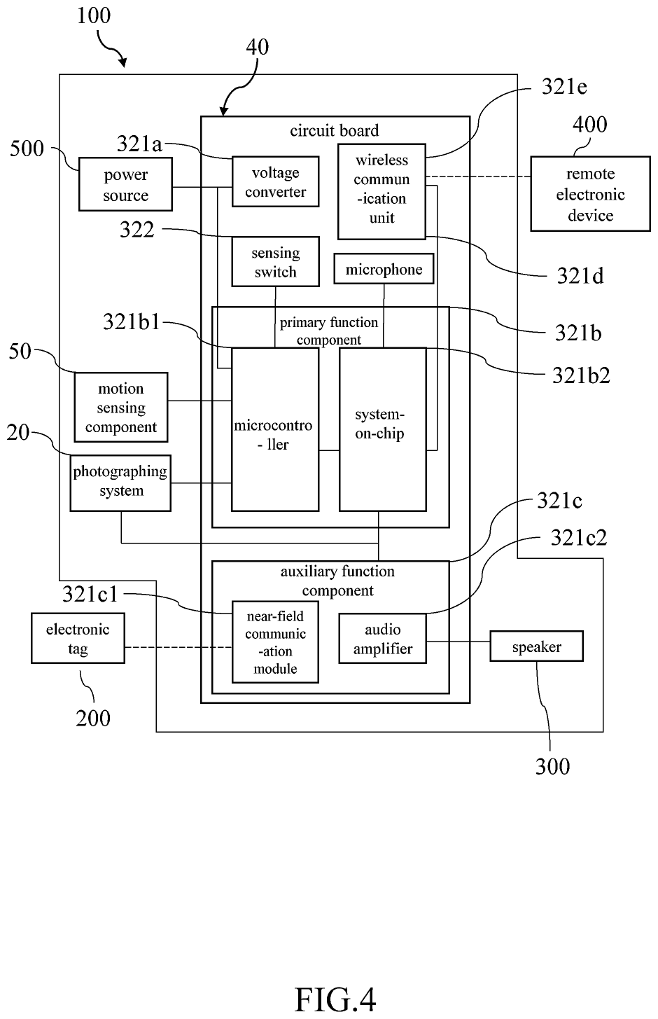

Referring to FIG. 2, the circuit board 30 is disposed in the housing 10 and is located between the front panel 11 and the rear circuit board P. The circuit board 30 has a second through hole 31 corresponding to the optical module 20, wherein the second through hole 31 is adapted to be penetrated by the camera lens 21 of the optical module 20. The circuit board 30 has an outer surface 32, wherein the outer surface 32 faces the front panel 11. A plurality of electronic components 321 is disposed on the outer surface 32. Referring to FIG. 3 and FIG. 4, the electronic components 321 include a voltage converter 321a, at least one primary function component 321b, and at least one auxiliary function component 321c, wherein the voltage converter 321a is adapted to be electrically connected to a power source 500. The at least one primary function component 321b is adapted to control the optical module 20 to power up and control the at least one auxiliary function component 321c to power up. In the current embodiment, the at least one primary function component 321b includes two primary function components 321b, wherein one of the two primary function components 321b is a microcontroller 321b1 and the other one of the two primary function components 321b is a system-on-chip 321b2 (SoC). The microcontroller 321b1 is electrically connected to the optical module 20, the voltage converter 321a, and the system-on-chip 321b2. The system-on-chip 321b2 is electrically connected to the optical module 20 and the at least one auxiliary function component 321c and receives and processes the image signal of the optical module 20. In the current embodiment, the power source 500 is a lithium battery. In other embodiments, the microcontroller 321b1 could be integrated into the system-on-chip 321b2 to form a primary function component 321b.

In the current embodiment, the at least one auxiliary function component 321c includes two auxiliary function components 321c, wherein one of the two auxiliary function components 321c is a near-field communication module 321cl and the other one of the two auxiliary function components 321c is an audio amplifier 321c2. The near-field communication module 321cl is adapted to sense an electronic tag 200, so that the electronic tag 200 could be a digital key to unlock a door; the electronic tag 200 could be an independent electronic tag or a built-in electronic tag of a device having a function of near-field communication such as a mobile phone and a smart watch. The audio amplifier 321c2 is adapted to be electrically connected to a speaker 300. The system-on-chip 321b2 could control the near-field communication module 321cl and the audio amplifier 321c2 to power up. In other embodiments, the at least one auxiliary function component 321c could include one auxiliary function component 321c such as the near-field communication module 321cl or the audio amplifier 321c2.

A wireless communication unit 321e and a microphone 321d are disposed on the outer surface 32 of the circuit board 30. The wireless communication unit 321e is electrically connected to the system-on-chip 321b2 and is connected to at least one remote electronic device 400 through a local area network. The remote electronic device 400 could be a mobile device or a communication host such as a mobile phone or a tablet computer. The microphone 321d is electrically connected to the system-on-chip 321b2 and is controlled by the system-on-chip 321b2 to power up. The microphone 321d is adapted to receive a sound of a visitor and cooperates with the speaker 300 which plays a sound of an inhabitant from the remote electronic device 400, so that a channel for the visitor and the inhabitant to have a voice conversation could be established. Additionally, the system-on-chip 321b2 could transmit the image signal of the optical module 20 to the remote electronic device 400 through the wireless communication unit 321e, thereby showing or recording the environmental image.

Referring to FIG. 2 to FIG. 4, the outer surface 32 of the circuit board 30 has a sensing area S, wherein the sensing area S corresponds to the opening 111 of the front panel 11. A sensing switch 322 and a thermally conductive circuit 323 are disposed on the outer surface 32 of the circuit board 30. The sensing switch 322 is located in the sensing area S and is electrically connected to the microcontroller 321b1. When the sensing switch 322 is triggered, the sensing switch 322 generates a trigger signal. The trigger signal is received by the microcontroller 321b1. The microcontroller 321b1 generates a notification signal according to the trigger signal and transmits the notification signal to the system-on-chip 321b2. The system-on-chip 321b2 transmits the notification signal, for example, to the remote electronic device 400 through the wireless communication unit 321e, thereby notifying the inhabitant that the visitor visits. The thermally conductive circuit 323 is laid out on the outer surface 32. Each of the electronic components 321 has a ground pin. The thermally conductive circuit 323 is electrically connected to the ground pin of each of the electronic components 321 and has an extending segment 323a, wherein the extending segment 323a is located in the sensing area S. The thermally conductive circuit 323 is adapted to transfer a thermal energy generated by an operation of the electronic components 321 to the sensing area S and is not located in an inner layer of the circuit board 30.

Referring to FIG. 2 and FIG. 5 to FIG. 8, the button assembly 40 is disposed in the housing 10 and is located in the opening 111. The button assembly 40 includes a pressing board 41, wherein the pressing board 41 corresponds to the sensing area S of the outer surface 32 and the sensing switch 322 of the outer surface 32. An elastic pad 411 is disposed on an inner side of the pressing board 41. The pressing board 41 has a peripheral edge 412. A gap 413 is formed around the peripheral edge 412. A plurality of recesses 414 is disposed on the peripheral edge 412. The peripheral edge 412 has a bottom peripheral edge 412a and a top peripheral edge 412b, wherein the bottom peripheral edge 412a of the pressing board 41 is in a curved shape which is dented downward as an example. The top peripheral edge 412b of the pressing board 41 is in a curved shape which protrudes upward as an example. The gap 413 has a bottom gap 413a and a top gap 413b, wherein the bottom gap 413a is formed around the bottom peripheral edge 412a of the pressing board 41. The top gap 413b is formed around the top peripheral edge 412b of the pressing board 41.

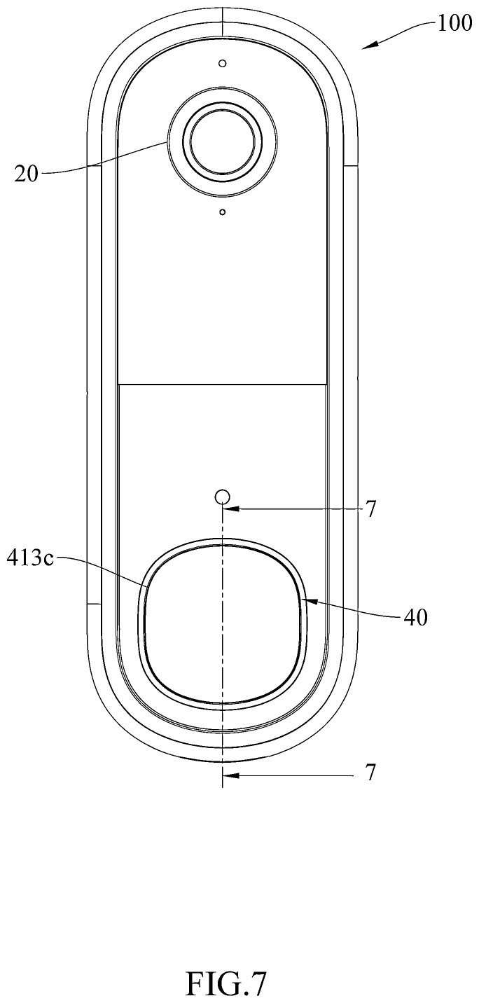

Referring to FIG. 7 to FIG. 9, a reference axis L is defined, wherein the reference axis Lis vertical to the outer surface 32 of the circuit board 30. When the pressing board 41 is pressed, the pressing board 41 moves towards the sensing switch 322 along the reference axis L. Along the reference axis L, the bottom peripheral edge 412a of the pressing board 41 and the bottom gap 413a of the gap 413 are located within a projection range of the extending segment 323a and correspond to an arcuate segment 323al of the extending segment 323a.

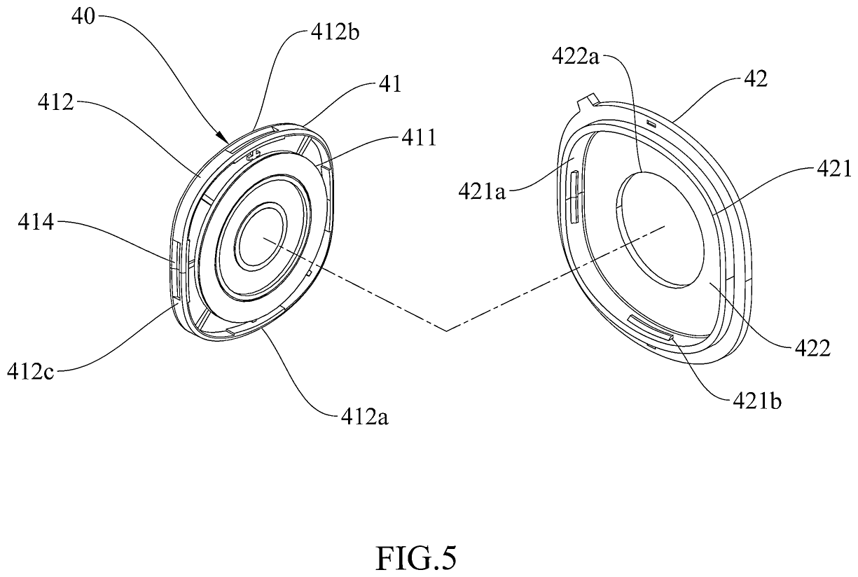

Referring to FIG. 3, in the current embodiment, the thermally conductive circuit 323 further includes two lateral segments 323a2, wherein the two lateral segments 323a2 are respectively connected to a left end and a right end of the extending segment 323a and extend from a top of the circuit board 30 to a bottom of the circuit board 30. The two lateral segments 323a2 are located in the sensing area S and are respectively located on a left side of the sensing switch 322 and a right side of the sensing switch 322. The peripheral edge 412 of the pressing board 41 has two lateral peripheral edges 412c (as shown in FIG. 5). The gap 413 has two lateral gaps 413c, wherein each of the two lateral gaps 413c is formed around each of the two lateral peripheral edges 412c. Each of the two lateral segments 323a2 corresponds to each of the two lateral peripheral edges 412c and each of the two lateral gaps 413c. Preferably, along the reference axis L, each of the two lateral peripheral edges 412c of the pressing board 41 and each of the two lateral gaps 413c are located within a projection range of each of the two lateral segments 323a2. In another embodiment, the two lateral segments 323a2 could be replaced with at least one lateral segment 323a2, wherein the at least one lateral segment 323a2 is connected to one of the two ends of the extending segment 323a or is connected to the two ends of the extending segment 323a to communicate the two ends of the extending segment 323a.

Referring to FIG. 5 to FIG. 9, in the current embodiment, the button assembly 40 further includes a fixing member 42, wherein the fixing member 42 has a fixing ring 421 and an inner board 422. The fixing ring 421 is located in the opening 111 and has an inner annular surface 421a. A plurality of stop blocks 421b corresponding to the recesses 414 of the pressing board 41 is disposed on the inner annular surface 421a, wherein each of the stop blocks 421b has a contour matching a contour of each of the recesses 414. The inner board 422 is connected to an inner end 421c of the fixing ring 421 and has a through hole 422a and an inner surface 422b, wherein the through hole 422a corresponds to the sensing area S and the sensing switch 322. The elastic pad 411 prevents a moisture of the outside of the housing 10 from passing through the through hole 422a, so that the sensing switch 322 and the electronic components 321 inside the housing 10 would not be affected by the moisture of the outside of the housing 10. The inner surface 422b of the inner board 422 has a peripheral edge portion 422b1, wherein the peripheral edge portion 422b1 is adjacent to the extending segment 323a of the thermally conductive circuit 323. In the current embodiment, the fixing ring 421 is made of light-transmitting plastic; a plurality of light-emitting diodes 324 are disposed on a part of the outer surface 32 of the circuit board 30 corresponding to the fixing ring 421, so that a light could pass through the fixing ring 421 to guide the visitor to a location of the button assembly 40. In other embodiments, a material of the fixing ring 421 could be selected upon the required demand; for example, the fixing ring 421 could be made of metal to accelerate a speed of a thermal conduction.

When the pressing board 41 is located in the fixing ring 421 and is installed in the doorbell device 100, the stop blocks 421b could be stuck at the recesses 414; the gap 413 is formed between the peripheral edge 412 of the pressing board 41 and the inner annular surface 421a of the fixing ring 421. At that time, the bottom gap 413a forms a first gap 413al and a second gap 413a2 along the reference axis L. The first gap 413al and the second gap 413a2 are spaced by the recesses 414 and the stop blocks 421b and are located within the projection range of the extending segment 323a. The pressing board 41 drives the elastic pad 411 to pass thorough the through hole 422a to trigger the sensing switch 322, so that the sensing switch 322 generates the trigger signal and the trigger signal is received by the microcontroller 321b1.

Because the bottom peripheral edge 412a of the pressing board 41 and the bottom gap 413a of the gap 413 are located within the projection range of the extending segment 323a, the thermal energy of the electronic components 321 conducted to the extending segment 323a of the thermally conductive circuit 323 could be easily transferred to the bottom peripheral edge 412a and the bottom gap 413a. In the current embodiment, the thermal energy of the extending segment 323a is transferred to the bottom peripheral edge 412a of the pressing board 41 and the bottom gap 413a of the pressing board 41 through the peripheral edge portion 422b1 of the inner board 422, but not limited thereto. The thermal energy of the extending segment 323a could be transferred to the bottom peripheral edge 412a and the bottom gap 413a through conduction, convection, or radiation. In this way, when the doorbell device 100 is disposed in a cold environment, an ice frozen from a moisture accumulating in the bottom gap 413a could be melted by the thermal energy of the extending segment 323a of the thermally conductive circuit 323.

Preferably, because the moisture does not easily accumulate in the top gap 413b, the thermally conductive circuit 323 is not disposed in a location of the outer surface 32 of the circuit board 30 corresponding to the top peripheral edge 412b of the pressing board 41 and the top gap 413b of the pressing board 41. In this way, the thermal energy of the thermally conductive circuit 323 could be concentrated in the extending segment 323a located in a bottom of the thermally conductive circuit 323 through the two lateral segments 323a2, thereby raising the thermal energy of the extending segment 323a; each of the two lateral segments 323a2 could also release a thermal energy to melt an ice frozen from a moisture accumulating in each of the two lateral gaps 413c.

In another embodiment, the peripheral edge 412 of the pressing board 41 of the button assembly 40 could directly correspond to a hole wall of the opening 111, so that the gap 413 is formed between the peripheral edge 412 of the pressing board 41 and the hole wall of the opening 111.

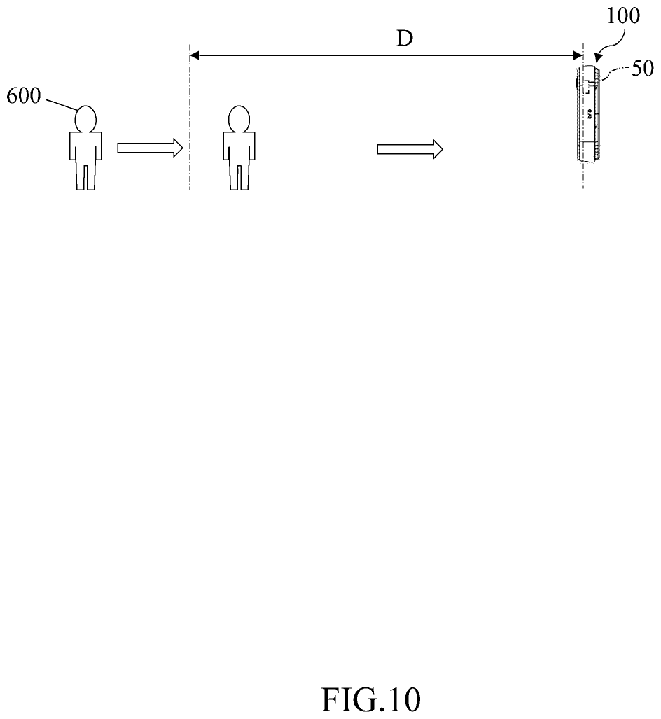

Referring to FIG. 2 and FIG. 4, in order to save an electric power of the power source 500, the primary function components 321b and the auxiliary function components 321c operate and generate the thermal energy only when the visitor comes. In the current embodiment, the doorbell device 100 includes a motion sensing component 50, wherein the motion sensing component 50 is disposed on the outer surface P1 of the rear circuit board P. In the current embodiment, the motion sensing component 50 is an infrared sensor such as a pyroelectric infrared sensor. A location of the front panel 11 corresponding to the motion sensing component 50 is made of an infrared transmitting material, and the circuit board 30 has a third through hole 34 corresponding to the motion sensing component 50, so that the motion sensing component 50 could detect a moving object 600 (e.g. human body) on the outside of the housing 10 through the third through hole 34 and the front panel 11 of the housing 10. The motion sensing component 50 is electrically connected to the microcontroller 321b1 and is adapted to detect the moving object 600 on the outside of the housing 10. Referring to FIG. 10, when a distance between the moving object 600 and the motion sensing component 50 is less than or equal to a predetermined distance D, the motion sensing component 50 generates a detection signal corresponding to the moving object 600 and the detection signal is received by the microcontroller 321b1. In the current embodiment, the predetermined distance D could be modified upon the required demand; preferably, the predetermined distance D is 10 m.

When the distance between the moving object 600 and the motion sensing component 50 is greater than the predetermined distance D, the doorbell device 100 is in a standby mode. In the standby mode, the voltage converter 321a and the microcontroller 321b1 are activated and generate a first thermal energy; the motion sensing component 50 stays turning on to continuously detect if the moving object 600 is on the outside of the housing 10. Preferably, a part of functions of the microcontroller 321b1 is activated (for example, the microcontroller 321b1 is in a sleep mode) for reducing power consumption; until the microcontroller 321b1 receives the detection signal of the motion sensing component 50, the microcontroller 321b1 would be woken.

When the microcontroller 321b1 receives the detection signal of the motion sensing component 50, the doorbell device 100 is in a maximum power mode. In the maximum power mode, the microcontroller 321b1 activates the system-on-chip 321b2 and controls the optical module 20 to power up to photograph the environmental image. The optical module 20 transmits the image signal to the system-on-chip 321b2. The system-on-chip 321b2 controls the at least one auxiliary function component 321c to power up. The voltage converter 321a, the microcontroller 321b1, the system-on-chip 321b2, and the at least one auxiliary function component 321c generate a second thermal energy. The second thermal energy is greater than the first thermal energy. The second thermal energy is conducted to the extending segment 323a of the thermally conductive circuit 323. More specifically, the second thermal energy is transferred to the inner annular surface 421a of the button assembly 40 along the reference axis L through the arcuate segment 323al of the extending segment 323a corresponding to the peripheral edge portion 422b1 of the fixing member 42 and the bottom peripheral edge 412a of the pressing board 41, so that the ice in the second gap 413a2 of the bottom gap 413a and the first gap 413al of the bottom gap 413a could be melted to facilitate the visitor to press the pressing plate 41. In this way, the pressing board 41 of the button assembly 40 could be normally pressed to move to trigger the sensing switch 322 to generate the trigger signal.

When the moving object 600 moves away from the doorbell device 100 and the distance between the moving object 600 and the motion sensing component 50 is greater than the predetermined distance D again, the doorbell device 100 would resume the standby mode, i.e., the microcontroller 321b1 controls the optical module 20 to turn off; the system-on-chip 321b2 controls the at least one auxiliary function component 321c to turn off and then the system-on-chip 321b2 is turned off; the voltage converter 321a and the microcontroller 321b1 are activated and generate the first thermal energy. Preferably, a part of functions of the microcontroller 321b1 is activated (for example, the microcontroller 321b1 is in the sleep mode), so that the electric power of the power source 500 could be saved.

With the aforementioned design, the doorbell device 100 of the present disclosure is provided with the thermally conductive circuit 323 disposed on the circuit board 30, so that the second thermal energy generated by the operation of the electronic components 321 could be conducted to the extending segment 323a of the thermally conductive circuit 323. With the disposition of the extending segment 323a corresponding to the peripheral edge portion 422b1 of the fixing member 42 and the bottom peripheral edge 412a of the pressing board 41 along the reference axis L, the thermal energy generated by the operation of the electronic components 321 is effectively transferred to a periphery of the button assembly 40, so that the ice in the bottom gap 413a could be melted and the pressing board 41 of the button assembly 40 could be normally pressed. Moreover, the doorbell device 100 could switch between the standby mode and the maximum power mode, so that before the visitor presses the pressing board 41 of the button assembly 40, the ice in the bottom gap 413a could be heated and melted without performing any extra process for melting the ice in the bottom gap 413a.

It must be pointed out that the embodiments described above are only some preferred embodiments of the present invention. All equivalent structures which employ the concepts disclosed in this specification and the appended claims should fall within the scope of the present invention.

What is claimed is:

1. A doorbell device, comprising:
a housing having a front panel, wherein the front panel has an opening;
an optical module disposed in the housing, wherein the optical module is controllable to power up to photograph an environmental image of an outside of the housing and outputs an image signal;
a circuit board disposed in the housing and having an outer surface, wherein the outer surface faces the front panel; a plurality of electronic components, a thermally conductive circuit, and a sensing switch are disposed on the outer surface of the circuit board; the plurality of electronic components comprise at least one primary function component and at least one auxiliary function component, wherein the at least one primary function component is electrically connected to the sensing switch, the optical module, and the at least one auxiliary function component; the at least one primary function component is adapted to control the optical module to power up and control the at least one auxiliary function component to power up; the at least one primary function component receives the image signal of the optical module and a trigger signal of the sensing switch; the outer surface of the circuit board has a sensing area, wherein the sensing area corresponds to the opening of the front panel and the sensing switch is located in the sensing area; the thermally conductive circuit is laid out on the outer surface of the circuit board and is electrically connected to the plurality of electronic components; the thermally conductive circuit has an extending segment, wherein the extending segment is located in the sensing area;
a button assembly disposed in the housing and located in the opening of the front panel; the button assembly comprises a pressing board, wherein the pressing board corresponds to the sensing area of the outer surface of the circuit board and the sensing switch of the outer surface of the circuit board; the pressing board is pressable to trigger the sensing switch to generate the trigger signal; the pressing board has a peripheral edge, wherein the peripheral edge has a bottom peripheral edge;
wherein the extending segment of the thermally conductive circuit corresponds to the bottom peripheral edge of the pressing board.

2. The doorbell device as claimed in claim 1, wherein the button assembly has a gap; the gap is formed around the peripheral edge of the pressing board and has a bottom gap, wherein the bottom gap is formed around the bottom peripheral edge of the pressing board; the extending segment of the thermally conductive circuit corresponds to the bottom peripheral edge of the pressing board and the bottom gap of the gap.

3. The doorbell device as claimed in claim 2, wherein a reference axis is defined; the reference axis is vertical to the outer surface of the circuit board; along the reference axis, the bottom peripheral edge of the pressing board and the bottom gap of the gap are located within a projection range of the extending segment.

4. The doorbell device as claimed in claim 2, wherein the button assembly comprises a fixing member; the fixing member has a fixing ring, wherein the fixing ring is located in the opening of the front panel and has an inner annular surface; the pressing board is located in the fixing ring; the gap is formed between the peripheral edge of the pressing board and the inner annular surface of the fixing ring.

5. The doorbell device as claimed in claim 4, wherein the fixing member has an inner board; the inner board is connected to an inner end of the fixing ring and has an inner surface, wherein the inner surface has a peripheral edge portion; the peripheral edge portion is adjacent to the extending segment of the thermally conductive circuit.

6. The doorbell device as claimed in claim 2, wherein the thermally conductive circuit further comprises two lateral segments; the two lateral segments are respectively connected to two ends of the extending segment and are respectively located on a left side of the sensing switch and on a right side of the sensing switch; the peripheral edge of the pressing board has two lateral peripheral edges; the gap has two lateral gaps, each of the two lateral gaps is formed around each of the two lateral peripheral edges; each of the two lateral segments of the thermally conductive circuit corresponds to each of the two lateral peripheral edges of the pressing board and each of the two lateral gaps of the pressing board.

7. The doorbell device as claimed in claim 1, wherein the bottom peripheral edge of the pressing board is in a curved shape; the extending segment has an arcuate segment corresponding to the bottom peripheral edge of the pressing board.

8. The doorbell device as claimed in claim 1, wherein each of the plurality of electronic components has a ground pin; the thermally conductive circuit is electrically connected to the ground pin of each of the plurality of electronic components.

9. The doorbell device as claimed in claim 1, further comprising a motion sensing component, wherein the motion sensing component is electrically connected to the at least one primary function component and is adapted to detect a moving object located on the outside of the housing; when a distance between the moving object and the motion sensing component is less than or equal to a predetermined distance, the motion sensing component generates a detection signal corresponding to the moving object; the at least one primary function component controls the optical module to power up and controls the at least one auxiliary function component to power up according to the detection signal.

10. The doorbell device as claimed in claim 9, wherein the at least one primary function component comprises a microcontroller and a system-on-chip; the microcontroller is electrically connected to the system-on-chip, the optical module, the sensing switch, and the motion sensing component; the system-on-chip is electrically connected to the optical module and the at least one auxiliary function component; when the microcontroller receives the detection signal, the microcontroller activates the system-on-chip and controls the optical module to power up; the system-on-chip receives the image signal and controls the at least one auxiliary function component to power up.

11. The doorbell device as claimed in claim 10, wherein the at least one auxiliary function component comprises a near-field communication module and an audio amplifier; the system-on-chip controls the near-field communication module and the audio amplifier to power up.

12. The doorbell device as claimed in claim 10, wherein the plurality of electronic components comprise a voltage converter; the voltage converter is adapted to be electrically connected to a power source and is electrically connected to the microcontroller.

13. The doorbell device as claimed in claim 12, wherein when the distance between the moving object and the motion sensing component is greater than the predetermined distance, the voltage converter and the microcontroller generate a first thermal energy; when the microcontroller receives the detection signal, the voltage converter, the microcontroller, the system-on-chip, and the at least one auxiliary function component generate a second thermal energy; the second thermal energy is greater than the first thermal energy; the second thermal energy is conducted to the extending segment of the thermally conductive circuit.
